(19) United States
(12) Patent Application Publication
(10) Pub. No.: US 2018/0313764 A1
(43) Pub. Date: Nov. 1, 2018

(54) TRIBOLUMINESCENCE APPARATUS AND METHOD FOR RAPID DETECTION OF HOMOCHIRAL CRYSTALLINITY IN PHARMACEUTICAL FORMULATIONS

(71) Applicant: Purdue Research Foundation, West Lafayette, IN (US)

(72) Inventors: Garth Jason Simpson, West Lafayette, IN (US); Paul David Schmitt, Zionsville, IN (US); Scott Robert Griffin, West Lafayette, IN (US); Casey Jake Smith, West Lafayette, IN (US)

(73) Assignee: Purdue Research Foundation, West Lafayette, IN (US)

(21) Appl. No.: 15/770,930

(22) PCT Filed: Sep. 27, 2016
(86) PCT No.: PCT/US16/54030

§ 371 Date: Apr. 25, 2018

Related U.S. Application Data
(60) Provisional application No. 62/233,391, filed on Sep. 27, 2015.

(51) Int. Cl. G01N 21/70; G01N 21/01

(52) U.S. Cl. CPC G01N 21/70; G01N 21/01

(57) ABSTRACT

An impact-driven apparatus and method to achieve triboluminescence of homochiral API crystals as a measurement tool for rapidly assessing the presence of trace crystallinity within nominally amorphous pharmaceutical powders. The apparatus may include a kinetic energy director and two plates which hold a sample for testing. The triboluminescence may also be achieve by an acoustic transducer.

### CROSS-REFERENCE TO RELATED APPLICATIONS

The present U.S. patent application is related to and claims the priority benefit of U.S. Provisional Patent Application Ser. No. 62/233,391, filed Sep. 27, 2015, the contents of which are hereby incorporated by reference in their entirety into the present disclosure.

### GOVERNMENT SUPPORT CLAUSE

This invention was made with government support under 1412888 awarded by the National Science Foundation. The government has certain rights in the invention.

### TECHNICAL FIELD

The present disclosure generally relates to detection of crystallinity, and in particular to a method and apparatus for rapid detection of homochiral crystallinity particularly in pharmaceutical formulations.

### BACKGROUND

This section introduces aspects that may help facilitate a better understanding of the disclosure. Accordingly, these statements are to be read in this light and are not to be understood as admissions about what is or is not prior art.

The chemical complexity of emerging drug molecules is rapidly increasing. This complexity is driven by the desire for more potent drugs with higher specificity and fewer side effects, and presents growing challenges in formulation design for ensuring bioavailability. Active pharmaceutical ingredients (APIs) and new chemical entities are typically required to be sufficiently hydrophobic to pass through cell membranes to enter the bloodstream and reach their targets. However, that hydrophobicity must be balanced by a sufficiently high aqueous solubility. As the size and complexity of the API increases, these mutually exclusive properties become increasingly difficult to simultaneously satisfy. Approximately 70-90% of potential API candidates suffer from poor aqueous solubility (BCS class II and IV). The added cost in the identification and characterization of abandoned candidates could easily reach into the hundreds of millions of dollars annually, industry wide.

Amorphous solid dispersions (ASDs) are an attractive option for increasing the bioavailability of APIs through the development of formulations containing higher free energy solid state forms, with correspondingly faster dissolution rates. However, the higher free energy comes at a price; ASDs are typically metastable with the potential to crystallize over widely varying timescales. Accordingly, accelerated stability studies in which an amorphous formulation is subjected to increased temperature and relative humidity remain the gold standard for characterizing long-term stability of an ASD. Such studies often require several months of exposure to harsh conditions before crystallinity is present at a level amenable to reliable quantitation. The time cost associated with accelerated stability studies produces a major bottleneck in the drug formulations pipeline.

The most widespread current approaches used for assessing crystallinity in APIs and API formulations include X-ray powder diffraction (PXRD), spectrochemical techniques including Raman, differential scanning calorimetry (DSC), solid state NMR (ssNMR), and scanning electron microscopy (SEM). Unfortunately, the detection limits for most of these techniques under normal conditions are on the order of 1-5% crystallinity, proving problematic for detecting trace crystallinity, particularly in formulations with low (˜5-10%) drug loadings as is becoming commonplace in modern pharmaceuticals. Second harmonic generation microscopy (SHG) has been used to rapidly detect and quantify trace crystallinity in amorphous formulations, showing detection limits in the sub-ppm regime. Unfortunately, the instrument costs associated with SHG create a practical barrier to ubiquitous implementation, restricting its use to a relatively small subset of well-funded and well-staffed facilities. There is therefore an unmet need for robust and compact measurement tools compatible with process analytical technology applications capable of identifying trace crystallinity within solid-state formulations.

### SUMMARY

According to one aspect of the present disclosure, an apparatus is provided, comprising a sample holder for holding a sample, the sample holder having at least one optically transparent plate and a covering member for securing the sample between the covering member and the transparent plate, wherein the sample is between and in mechanical contact with the transparent plate and the covering member, a kinetic energy director configured to deliver kinetic energy impulses to the sample through the sample holder to induce triboluminescence of the sample, and a light detection unit configured to detect luminescence from the sample and output a signal representative of the level of luminescence. The apparatus may include a recording device to record a temporal response of the light detection unit and a trigger device which senses an impact event on the sample and outputs a trigger signal to the recording device. A timing controller may also be included, the timing controller a operatively connected to the kinetic energy director and the recording device, the timing controller configured to synchronize actuation of the kinetic energy director and the recording device to cause the recording device to capture the output signal of the light detection unit when the kinetic energy director strikes the sample holder.

According to another aspect, an apparatus is provided, comprising a sample holder for holding a sample, the sample holding having at least one cavity for containing a liquid sample, an acoustic transducer configured to direct sonic energy impulses to the sample to induce sonotriboluminescence of the sample, and a light detection unit configured to detect luminescence from the sample and output a signal representative of the level of luminescence. The apparatus may include a recording device to record a temporal response of the light detection unit and a trigger device which senses an impact event on the sample and outputs a trigger signal to the recording device. A timing controller may also be included, the timing controller a operatively connected to the kinetic energy director and the recording device, the timing controller configured to synchronize actuation of the kinetic energy director and the recording device to cause the recording device to capture the output signal of the light detection unit when the kinetic energy director strikes the sample holder.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a diagram showing an apparatus for detecting crystallinity of a sample using triboluminescence according to one embodiment.

FIG. 2 is a diagram showing an apparatus for detecting crystallinity of a sample using sonotriboluminescence according to one embodiment.

FIG. 3 is a plot showing a time trace of an amorphous excipient offset from the time trace of a 0.1% by mass crystalline griseofulvin using the apparatus of FIG. 1.

FIG. 4 shows the R² value of the linear fit which suggests a linear relationship between generated signal and the % crystallinity by mass.

FIG. 5 is a raw time-trace of the voltage from a photomultiplier tube following a series of acoustic impulses using the system of FIG. 2.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

Presented herein impact-driven triboluminescence of homochrial API crystals as a novel measurement tool for rapidly assessing the presence of trace crystallinity within nominally amorphous pharmaceutical powders. According to one aspect, the disclosed measurement apparatus has the advantage of providing accurate measurement using a simple device with correspondingly low materials costs.

Triboluminescence is a phenomenon in which mechanical action results in emission of optical radiation. Bright triboluminescence arises when the mechanic perturbation couples to electric field generation due to piezoelectricity, which can then result in light emission, either by dielectric breakdown or through energy transfer to fluorophores. Based on this mechanism, efficient triboluminescence is expected in crystals that are both piezoelectrically active and are capable of supporting fluorescence.

Crystals of homochiral molecules are constructed from noncentrosymmetric building blocks, and therefore must adopt noncentrosymmetric lattices. Noncentrosymmetry is also a requirement for piezoelectricity, such that the overwhelming majority of chiral crystals fall into space groups that are piezoelectrically active. Furthermore, approximately 75% of new small molecule drug candidates contain aromatic groups that can support ultraviolet fluorescence. The presently disclosed apparatus and method utilize triboluminescence for fast and simple identification of trace crystallinity within otherwise amorphous materials.

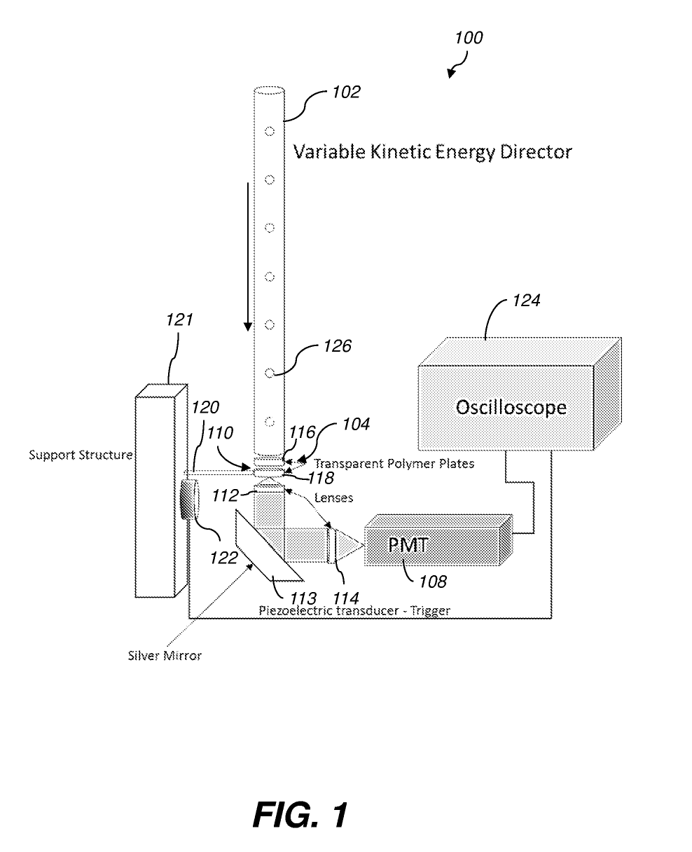

FIG. 1 illustrates an apparatus 100 for pharmaceutical powders analysis according to one embodiment. The apparatus 100 includes a kinetic energy director 102, a sample holder 104, a lens unit 106, and light detector, such as a photomultiplier tube (PMT) 108. In one embodiment, the sample holder 104 includes a first transparent plate 116 and a second transparent plate 118, between which a powder sample 110 is sandwiched. In one embodiment, the plates 116 and 118 are made of plexiglass, which is flexible enough to withstand impact yet rigid enough to impart sufficient force on the sample 110. The kinetic energy director may comprise, for example, a weight (e.g., ball 126), which falls through a tube 128 and impacts the sample holder. In other embodiment, the kinetic energy director may comprise a solenoid which drives an impact member, as described further below. In certain embodiments, the lens unit 106 may include a first lens 112, mirror 113 and a second lens 114 as shown, although more or less than two lenses may be used depending on the needs of the application.

In operation, kinetic energy impulses are delivered to the sample holder 104, mechanically compressing the sample 110 between the plates 116 and 118 to induce triboluminescence. Light emitted by the sample 110 is then collimated by the lens 112, redirected 90 degrees by a mirror 113, and then collected and focused onto the PMT 108 by lens 114. The PMT 108 outputs a voltage signal which corresponds to the level of light entering the PMT 108. In certain embodiments, the PMT 108 output is connected to a recording device 124. The recording device 124 may comprise an oscilloscope. An example of a suitable oscilloscope is the Tektronix Model TDS 3054B. Digital oscilloscopes may be as the recording device and further connected to a computing device for further recording, analysis, and processing of the data received from the detector 108. The recording device 124 records the temporal response of the luminescence from the sample 110. In certain embodiments, a trigger unit 122 is included which is mechanically connected to the sample holder by a member 120 and a support structure 121. The trigger unit may comprise a piezoelectric transducer, such as a lead zirconate titanate (PZT) ceramic piezoelectric transducer. The oscilloscope 124 is triggered by the trigger unit 122 based on detection of an acoustic wave produced upon impact of the sample. The trigger unit 122 may reduce noise by gating the detection to the moment of sample impact and signal generation. To minimize background, the PMT 108 and the sample holder 104 are physically separated from each other by an air gap. This design of the plates 116 and 118 allows the kinetic energy to be transferred evenly across the sample 110, while reducing the risk of transfer of material to the mechanical impulse generator (e.g., brass ball). The kinetic energy impulse in the embodiment of FIG. 1 is generated by an accelerated brass ball (74g) dropped from a height of 3.5 ft, although smaller or greater heights may be used. It should be appreciated that although in this embodiment, the kinetic energy impulses are achieved by an accelerated ball, such reference is not intended to be limiting. Rather, any means for achieving kinetic energy impulses sufficient for inducing triboluminescence can be used. For example, in a further embodiment, instead of a tube-and-ball arrangement, the energy director 102 may comprise an electromechanical solenoid having a coil surrounding a movable striking member which strikes the sample holder (thereby imparting mechanical force upon the sample) when a current is directed to the coil, and retracts away from the sample holder after the strike. In addition, the trigger signal to the recording device 124 may be implemented using an electronic timing controller (in one example, an Arduino Uno R3 microcontroller) connected to the oscilloscope, instead of a piezoelectric transducer. For example, such a timing controller may be configured to trigger the recording device 124 at or around the same time the solenoid is energized to strike the sample.

In addition, still referring to FIG. 1, although transparent polymer plates are described in the illustrated embodiment, it should be appreciated that other materials can form the transparent plates 116 and 118, provided they possess sufficient optical transparency for visible or ultraviolet light propagation, rigidity for uniform kinetic energy transfer to the sample 110, and plasticity to reduce the probability of fracture upon energy transfer from the kinetic energy director. Examples include but are not limited to sapphire and polymers. In further embodiments, the sample holder may comprise a single plate, onto which a sample is placed, and a film or tape is placed onto the plate to secure the sample between the tape and the plate. In such embodiments, the kinetic energy director would strike the tape and cause luminescence to be emitted from the sample. In addition, multiple samples and corresponding sample holders may be mounted upon an automatic feed device for high throughput applications. The automatic sample feed device may be operatively connected to the timing controller, such that after a strike event, the feed device removes the current sample (with the associated sample holder) from the sensing zone and advances the next sample into position for detection.

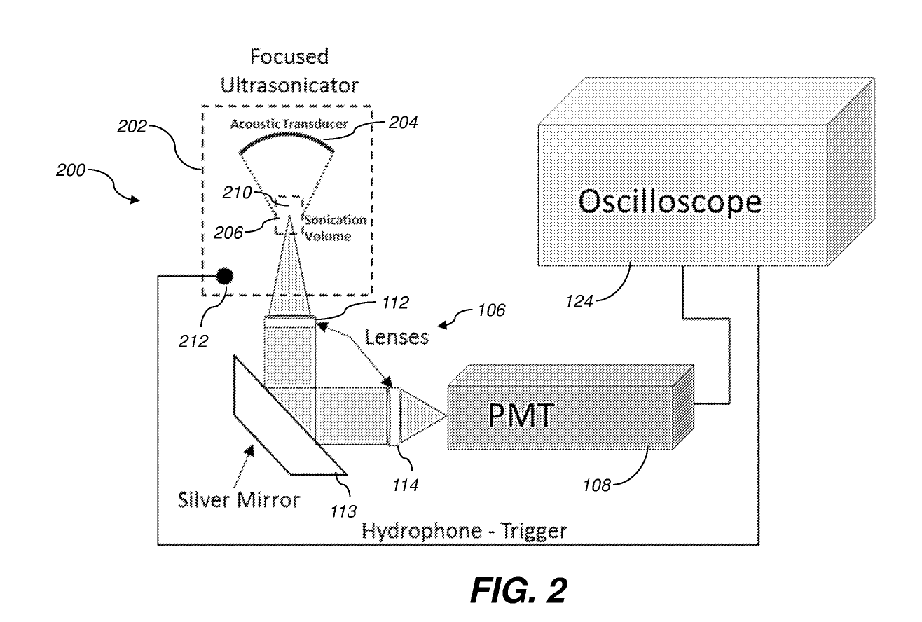

FIG. 2 shows an apparatus 200 similar to apparatus 100, wherein sonotriboluminescence is utilized to detect crystallization in a liquid or slurry sample 210. In the embodiment of FIG. 2, the, the kinetic energy director 202 comprises an acoustic transducer 204 which directs acoustic energy to a sonication volume 206 containing the sample 210. The sheer forces arising during the formation and collapse of microscopic cavities within the liquid sample 210 results in disruption of microcrystals contained therein. In sonotriboluminescence, the disruption of noncentrosymmetric crystals results in a substantial increase in luminescence relative to the sonoluminescence background, providing for crystal-specific detection of chiral API crystals within slurries and crystal suspensions to inform feedback for optimization of synthetic and manufacturing procedures. In the embodiment of FIG. 2, the trigger may comprise a hydrophone 212, although other triggering devices appropriate for sensing sonic energy may also be used.

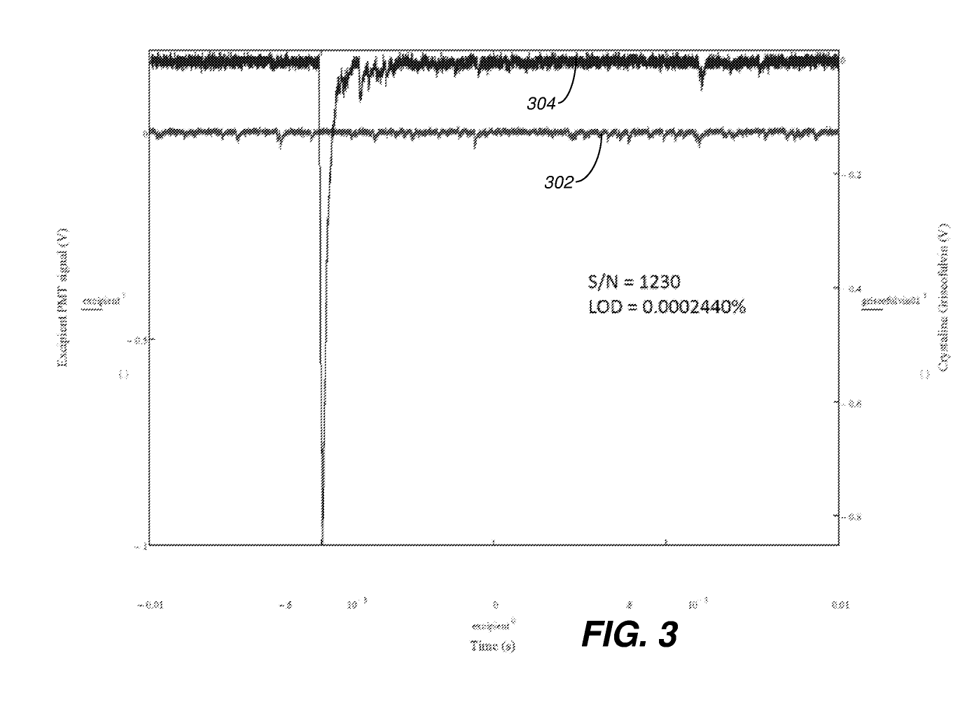

The apparatus of FIG. 1 and FIG. 2 may be used to qualitatively detect trace crystallinity in amorphous API formulations. FIG. 3 shows a time trace 302 of the detector output for a pure amorphous excipient (hydroxypropylmethyl cellulose acetate succinate, or HPMCAS) compared to a time trace 304 of a mixture of 0.1 wt % crystalline griseofulvin in the same amorphous excipient, produced in one example test. The signal to noise ratio (SNR) was achieved from replicates of the pure amorphous excipient averaged together as the noise, and the replicates of the 0.1 wt % sample as the signal. Based on the SNR of the measurements, the detection limits for crystalline griseofulvin was determined to be 15 ppm by weight, which is approximately three orders of magnitude lower than prior art benchtop instruments for crystalline detection and rivals the detection limits of SHG. For comparisons, the detection limits of Raman spectroscopy, differential scanning calorimetry, and powder X-ray diffraction are typically on the order of a few percent for routine analysis using benchtop systems. The capability of the presently disclosed apparatus and method as a cost effective solution to the need of rapid Boolean identification of trace crystallinity within solid-state formulations is superior to known methods.

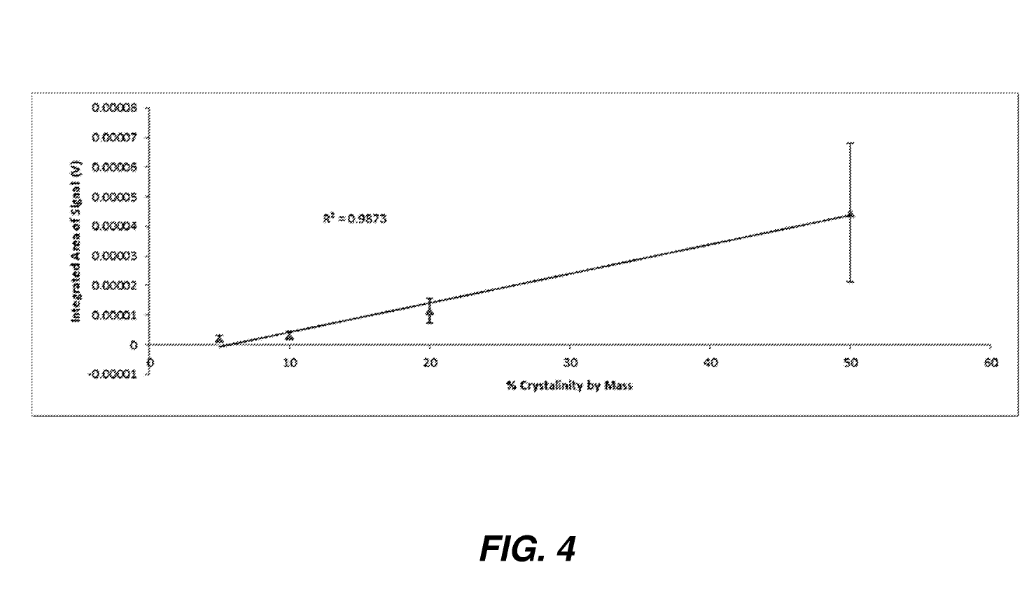

FIG. 4 shows the linear relationship between the wt % of crystallinity and signal generated within samples for triboluminescence. Knowing the linear relationship, the LOD was calculated from the theoretical signal generated from a sample that would give SNR of 3 compared to the signal generated from the samples used in FIG. 3, and found to be 15 ppm by weight. The error bars represent 1 standard deviataion from three measurements at each crystallinity.

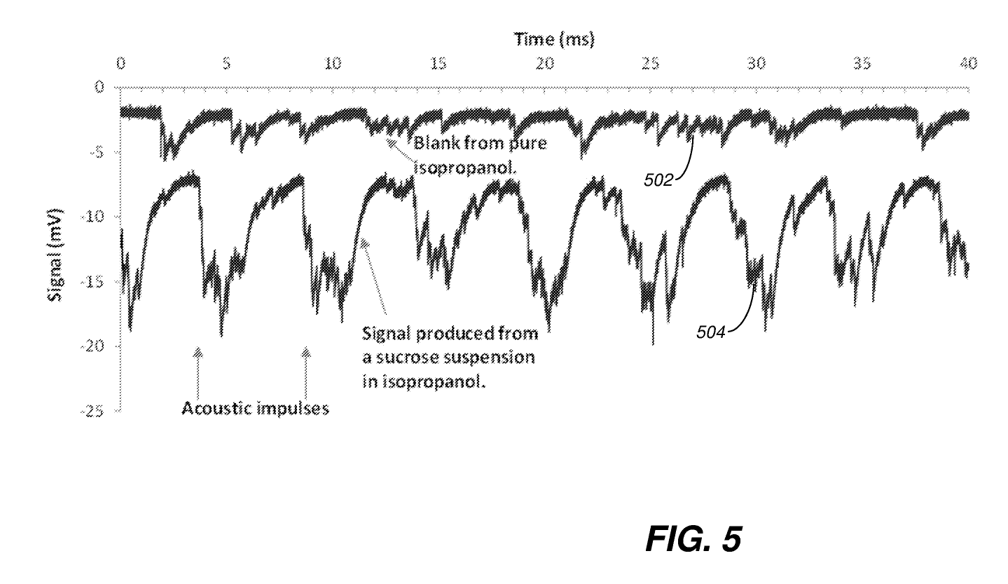

In FIG. 5, results are shown for an example suspension using the sonotriboluminescence apparatus 200 of FIG. 2. The trace 502 corresponds to a blank, with weak photon emission. A significant enhancement in signal output (trace 504) is observed in the presence of sucrose crystals suspended in the same solvent. A substantial increase in ultrasound-induced light emission is observed in the presence of chiral crystals (e.g., sucrose) compared to similar measurements performed using pure solvent (isopropanol).

Those skilled in the art will recognize that numerous modifications can be made to the specific implementations described above. The implementations should not be limited to the particular limitations described. Other implementations may be possible.

1. An apparatus, comprising:
a sample holder for holding a sample, the sample holder having at least one optically transparent plate and a covering member for securing the sample between the covering member and the transparent plate, wherein the sample is between and in mechanical contact with the transparent plate and the covering member;
a kinetic energy director configured to deliver kinetic energy impulses to the sample through the sample holder to induce triboluminescence of the sample; and
a light detection unit configured to detect luminescence from the sample and output a signal representative of the level of luminescence.

2. The apparatus of claim 1, wherein the light detector comprises a photomultiplier tube.

3. The apparatus of claim 2, wherein the signal output by the light detection unit is a voltage signal.

4. The apparatus of claim 1, further comprising a recording device to record a temporal response of the light detection unit.

5. The apparatus of claim 4, wherein the recording device is an oscilloscope.

6. The apparatus of claim 4, further comprising a trigger device which senses an impact event on the sample and outputs a trigger signal to the recording device.

7. The apparatus of claim 1, wherein the at least one plate and the cover are configured to be rigid enough to transfer energy from the kinetic energy director to the powder.

8. The apparatus of claim 7, wherein the at least one plate and the cover are configured to be soft enough such that they are not damaged by the kinetic energy impulses.

9. The apparatus of claim 7, wherein the at least one plate is made of a polymer.

10. The apparatus of claim 9, wherein the at least one plate is made of plexiglass.

11. The apparatus of claim 7, wherein the at least one plate is made of sapphire.

12. The apparatus of claim 1, further comprising an air gap between the sample and the light detection unit, the air gap being configured to reduce background noise.

13. The apparatus of claim 1, wherein the apparatus is configured for rapid assessment of the qualitative presence of crystallinity within a sample.

14. The apparatus of claim 1, wherein the cover is a tape.

15. The apparatus of claim 1, wherein the kinetic energy director comprises an electromechanical solenoid having a coil surrounding a movable striking member which strikes the sample holder to impart mechanical force upon the sample when the coil is energized.

16. The apparatus of claim 1, further comprising a timing controller operatively connected to the kinetic energy director and the recording device, the timing controller configured to synchronize actuation of the kinetic energy director and the recording device to cause the recording device to capture the output signal of the light detection unit when the kinetic energy director strikes the sample holder.

17. The apparatus of claim 1, further comprising an electrical power supply operatively connected to the kinetic energy director and the timing controller, the power supply configured to drive the kinetic energy director when instructed by the timing controller.

18. The apparatus of claim 1, wherein the sample is a pharmaceutical powder.

19. An apparatus, comprising:
a sample holder for holding a sample, the sample holding having at least one cavity for containing a liquid sample;
an acoustic transducer configured to direct sonic energy impulses to the sample to induce sonotriboluminescence of the sample; and
a light detection unit configured to detect luminescence from the sample and output a signal representative of the level of luminescence.

20. The apparatus of claim 19, wherein the signal output by the light detection unit is a voltage signal.

21. The apparatus of claim 20, wherein the light detection unit comprises a photomultiplier tube.

22. The apparatus of claim 19, further comprising a recording device to record a temporal response of the light detection unit.

23. The apparatus of claim 22, wherein the recording device is an oscilloscope.

24. The apparatus of claim 22, further comprising a trigger device operatively connected to the sample holder and the recording device, wherein the trigger device senses a sonic energy impulse event on the sample and outputs a trigger signal to the recording device.

25. The apparatus of claim 24, wherein the trigger device is a hydrophone.

26. The apparatus of claim 19, wherein the sample is a pharmaceutical slurry.
